(19) United States
(12) Patent Application Publication
(10) Pub. No.: US 2007/0074226 A1
(43) Pub. Date: Mar. 29, 2007

(54) Systems and methods for device driver isolation

(76) Inventors: Vincent J. Zimmer, Federal Way, WA (US); Michael Rothman, Puyallup, WA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/238,177

(22) Filed: Sep. 28, 2005

(51) Int. Cl. G06F 9/455; G06F 9/46

(52) U.S. Cl. 719/321; 718/1

(57) ABSTRACT

Systems and methods are described herein to provide for device driver isolation from a host operating system on a computing device. Other embodiments include apparatus and system for control of two or more virtual machines, each of the virtual machines isolated from all other virtual machines. Further embodiments include methods for executing an operating system wherein the device driver is isolated from the operating system. Other embodiments are described and claimed.

### TECHNICAL FIELD

Various embodiments described herein relate generally to device driver configuration and more particularly for increased stability of host operating system operations.

### BACKGROUND

Presently, a computer user extending functionality of their computing device seeks to do so by adding a hardware device to the computing device. They may wish to have scanning capability and would then hook up a scanner to their device and then proceed to scan their pictures or documents. Each of these hardware devices requires the loading of a driver into the host operating system.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a high level block diagram of a system according to embodiments of the present invention;

FIG. 2 is a high level block diagram of a device according to embodiments of the present invention;

FIG. 3 is a flowchart of a method according to embodiments of the present invention;

FIG. 4 is a flowchart of a method according to embodiments of the present invention; and

FIG. 5 is a flowchart of a method according to embodiments of the present invention.

### DETAILED DESCRIPTION

In the following detailed description of embodiments of the invention, reference is made to the accompanying drawings which form a part hereof, and in which are shown, by way of illustration, specific preferred embodiments in which the subject matter may be practiced. These embodiments are described in sufficient detail to enable those skilled in the art to practice them, and it is to be understood that other embodiments may be utilized and that logical, mechanical, and electrical changes may be made without departing from the spirit and scope of the present disclosure. Such embodiments of the inventive subject matter may be referred to, individually and/or collectively, herein by the term “invention” merely for convenience and without intending to voluntarily limit the scope of this application to any single invention or inventive concept if more than one is in fact disclosed.

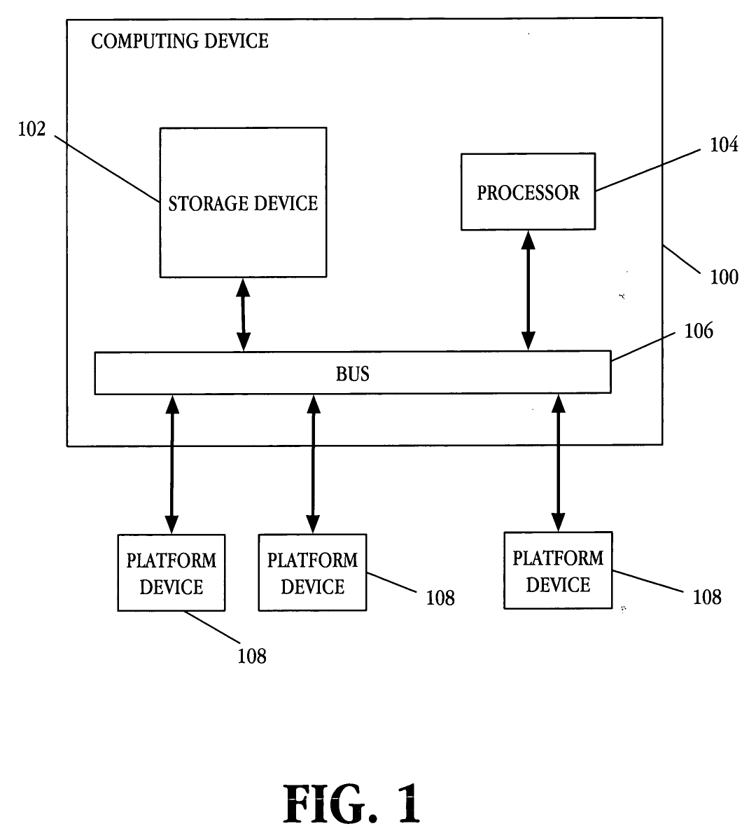

FIG. 1 is a high level block diagram of a system according to embodiments of the present invention. In an embodiment, a computing device 100 includes a storage device 102 and a processor, 104. In an embodiment, the storage device 102 and the processor are communicatively coupled through a communications bus 106. In an embodiment, the computing device 100 is coupled to one or more platform devices 108. In one embodiment, the computing device is coupled to the one or more platform devices 108 through the communications bus 106. The communications bus 106 represents one or more busses, e.g., USB (Universal Serial Bus), FireWire, PCI, ISA (Industry Standard Architecture), X-Bus, EISA (Extended Industry Standard Architecture), or any other appropriate bus and/or bridge (also called a bus controller).

In an embodiment, the computing device 100 is configured to execute machine readable instructions contained on the storage device 102 implementing an operating system and other software applications. Operating systems may include operating systems such as Windows ®, UNIX, Linux, Macintosh ® operating systems, as well as operating systems embedded on a processor. The computing device may include, without limitation, desktop PC, server PC, PDA, etc.

In an embodiment, the processor 104 is configured to execute machine-readable instructions contained on the storage device 102, the machine-readable instructions to cause an operation to be performed on the computing device 100 or any of the one or more platform devices 108 coupled to the computing device.

In an embodiment, the one or more platform devices 108 are hardware devices configured to be removably coupled to the bus. Such devices include, without limitation, display devices, input devices, mass storage devices, multimedia storage devices, and the like. In such an arrangement, a user connecting a device causes operations on the storage device meant to configure and drive the platform device 108. More commonly, the computing device 100 loads a device driver from the storage device 102. In some examples, the device driver is executed within the operating system. In practice loading additional software code into the operating system causes the potential for instability and increases the possibility that the operating system itself will crash or cease to operate.

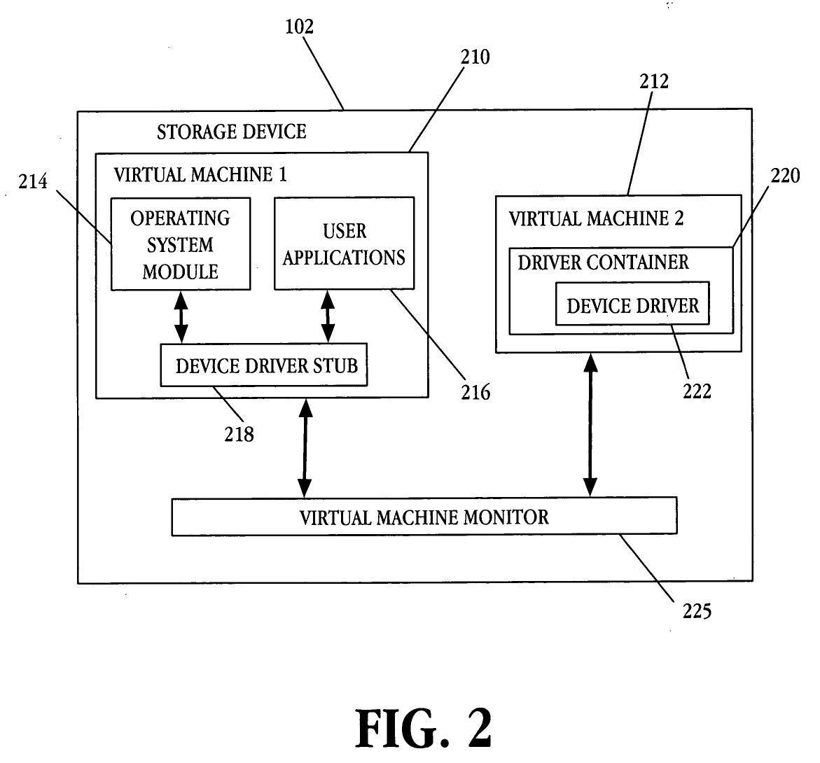

FIG. 2 is a high level block diagram of a device according to embodiments of the present invention. The storage device 102 includes machine readable instructions which when executed cause two or more virtual machines 210 and 212 to be executed. The first virtual machine 210 includes an operating system 214 and one or more user applications 216, each of which are coupled to at least one device driver stub 218. The second virtual machine includes a driver container 220, which further includes a device driver 222. In a further embodiment, the storage device contains additional machine-readable instructions which when executed cause a virtual machine monitor 225 to be executed. In such an arrangement the first virtual machine 210 is coupled to the second virtual machine 212 through the virtual machine monitor 225. In an embodiment, the virtual machine monitor 225 is further coupled to one or more of the platform device 108 (not shown).

In an embodiment, the first virtual machine 210 and the second virtual machine 212 are coupled through a virtual machine monitor 225 and are not configured to directly exchange data items between them. In other words, the software executed within the first virtual machine 210 is isolated from that being executed on the second virtual machine 212. “Isolated” in the context of the present discussion is intended to mean that software executing in one virtual machine is not able to alter, modify, read, or otherwise affect the code store or executable code that is running in any other virtual machine.

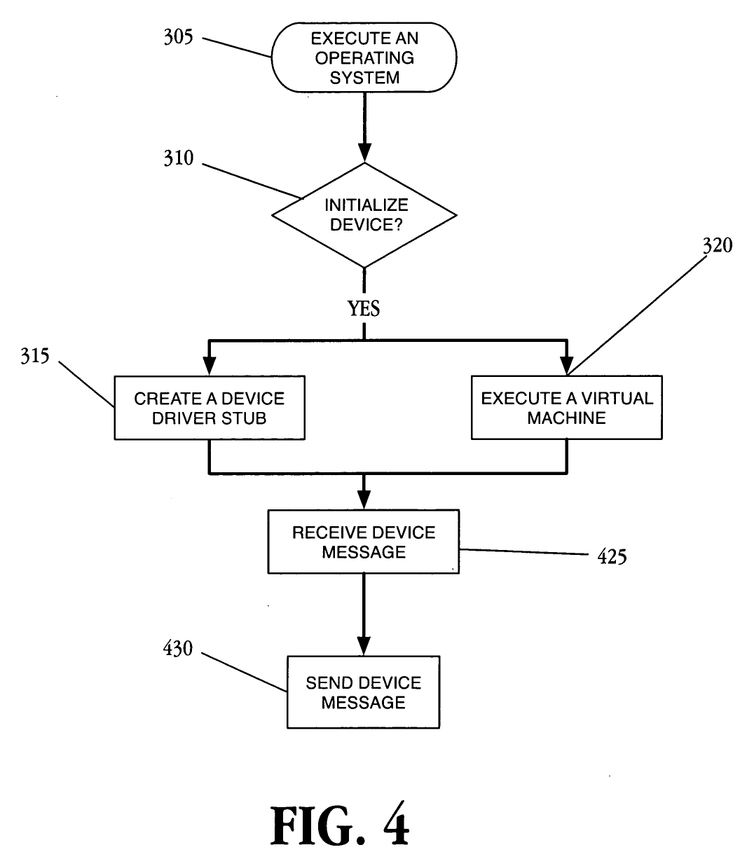

In an embodiment, the device driver stub 218 is a pointer to one or more drive containers 220. The device driver stub 218 is executed as a Ring 0 software application. Ring 0 software applications are applications that are executed in an environment which provides privileged access to the widest range of computing device resources. As a result of this privileged access, Ring 0 software applications create a risk of instability within the computing device as the interactions of the software code being executed and that of the operating system are unknown by the software developers of the operating system. This instability is the leading cause of understood computer crashes and account for over 50% of computer crashes. In an embodiment, the device driver stub 218, though a Ring 0 software application, is configured to only receive messages from the operating system 214 and the one or more user applications 216 that are addressed to platform devices and direct them appropriately. Appropriately directing the messages will be discussed in more detail below with respect to FIG. 4.

In an embodiment, the second virtual machine 212 includes a driver container 220, which further includes a device driver 222. In an embodiment, the device driver 222 is configured to send messages to one or more platform devices 108, the messages intended to cause some change in the operations of the platform device 108. These changes include, without limitation and are provided herein solely for illustrative purposes, causing a change in the image displayed on an display device, storing or retrieving data from a mass storage device, receiving input data from a human interface device such as a mouse. The device driver 222 is configured to be executed as a Ring 0 software application as discussed above. However, the device driver 222 described here is isolated from the operating system 214 contained in the first virtual machine 210 so that the device driver 222 is unable to alter, modify, read, or otherwise affect the code store or executable code that is running in the first virtual machine 210.

In an embodiment, the virtual machine monitor 225 is a software module configured to control the operations of one or more virtual machines. In the context of the above discussion, the virtual machine monitor 225 is configured to start, re-start and monitor the operations of the first virtual machine 210 and the second virtual machine 212. In a further embodiment, the virtual machine monitor 225 is configured to receive messages from the one or more virtual machines and send those messages. Through this mechanism, messages sent from the device driver stub 218 can be directed to one or more device drivers 222.

Though depicted here with respect to FIG. 2 as a first virtual machine 210 and a second virtual machine 212 it should be understood that multiple instances of each may be executed without departing from the scope of the present discussion. Each of the virtual machines in which a driver container 220 is contained is coupled to at least one platform device 108 such that each of the device drivers 222 are not only isolated from the first virtual machine 210, but are also isolated from other virtual machines 212. Additionally, there may be more then one instance of the first virtual machine 212 such that multiple operating systems 214 are executed on a single computing device.

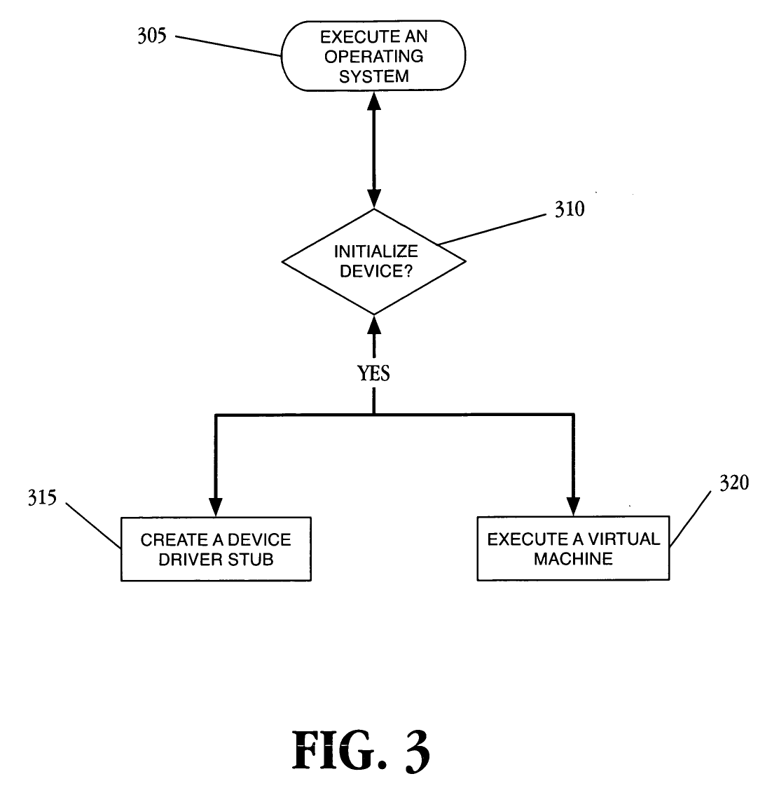

FIG. 3 is a flowchart of a method according to embodiments of the present invention. In an embodiment, the operations in FIG. 3 are carried out on the virtual machine monitor 225 as contemplated in FIG. 2 and described above.

At block 305, an operating system is executed. As is well known in the field, during system start or re-start, one or more of the platform devices coupled to the computing device requires some device driver 222 to be loaded to allow communications between the platform device and the operating system. In one embodiment, the virtual machine monitor 225 causes a virtual machine to be executed from the storage device 102. The virtual machine is configured as discussed above with respect to the first virtual machine 210. At block 310 it is determined if a device needs to be initialized. This determination may be made at system start-up, such as when the computing device 100 is first powered on, or re-started, but also may occur due to a new platform device 108 being attached to the computing device, such as a mass storage device being connected. Additionally, the virtual machine monitor 225 may initialize more then one device during these operations, the order of which is outside the scope of the present discussion.

At block 315, the virtual machine monitor 225 causes a device driver stub 218 to be executed in the first virtual machine. In an alternate embodiment, the virtual machine monitor 225 causes a device driver stub 218 to be initiated in virtual machine other then the first virtual machine, that virtual machine configured similarly to the first virtual machine as described above. At block 320, the virtual machine monitor 225 causes a virtual machine to be executed, the virtual machine containing a driver container 220 and a device driver 222, the device driver 222 the subject of the determination at block 310. Each of the devices that are determined to be initialized at block 310 causes a distinct and isolated virtual machine to be executed, each of which includes a driver container 220 which further includes a device driver 222 configured to communicate with the device to be initialized. Through these operations, each of the several devices communicates with a device driver 222 that is isolated from other device drivers. This is advantageous in that when a particular device driver 222 ceases to operate, it does not have the ability to alter operations on any of the other virtual machines being controlled by the virtual machine monitor 225. In one embodiment, the device driver stub 218 created at block 315 and the virtual machine executed at block 320 are performed concurrently. In another embodiment, operations to execute the virtual machine at block 320 are performed prior to the creation of the device driver stub 218 at block 315. In such an arrangement, during the creation of the device driver stub 218 at block 315, the device driver stub 218 is configured with an address associated with the location of the virtual machine executed at block 320. In yet another embodiment, operations to create the device driver stub 218 at block 315 are performed prior to the execution of the virtual machine at block 320.

FIG. 4 is a flowchart of a method according to embodiments of the present invention. In an embodiment, the operations in FIG. 4 are carried out on a virtual machine monitor 225 as contemplated in FIG. 2 and described above. The operations depicted in FIG. 4 are similar to those in FIG. 3 with the addition of operations occurring after the configuration described above with respect to FIG. 3.

Continuing from the operations described above and at some point in time after the initial configuration is established, an instruction from the operating system or a user application requires some instruction to be sent to a platform device. In an embodiment, the device driver stub 218 receives a device message and sends the device message. At block 425 the device message is received by the virtual machine monitor 225. In one embodiment, the message is addressed to a specific device driver 222 or unicast to the specific device driver 222. In such an arrangement, when the device driver stub 218 was first created, it was configured with the address of the virtual machine containing the driver container 220 which further includes the device driver 222. As the device message is received from the operating system or a user application, the device driver stub 218 sends that device message to the virtual machine monitor 225 already addressed. In an alternate embodiment, the device driver stub 218 is not configured with the address of the device driver 222 contained in the driver container 220 and is multicast to all device drivers. In such an arrangement, the device driver stub 218 passes any device message it receives from the operating system or a user application directly to the virtual machine monitor 225 without addressing the device message. In the first embodiment, the virtual machine monitor 225 sends the device message at block 430 to the appropriate virtual machine as indicated in the address of the device message the virtual machine monitor 225 received at block 420. In the second embodiment, the virtual machine monitor 225 sends the device message at block 430 to all virtual machines. In this arrangement, the computational cost to the device driver stub 218 in the first virtual machine is negligible as it is merely passing every message along.

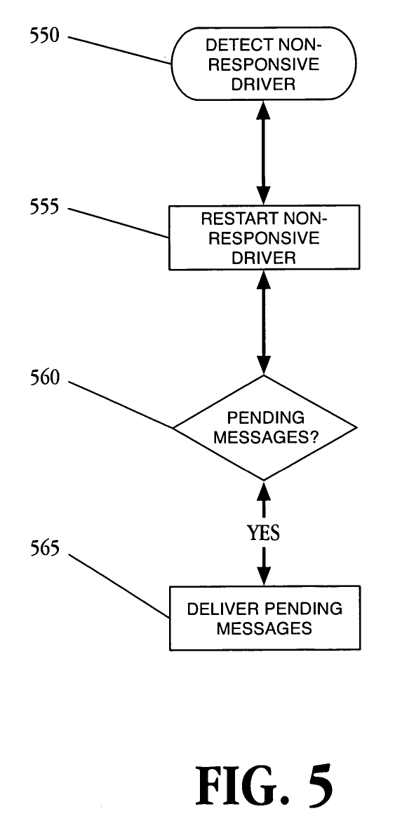

FIG. 5 is a flowchart of a method according to embodiments of the present invention. In an embodiment, the operations in FIG. 4 are carried out on a virtual machine monitor 225 as contemplated in FIG. 2 and described above.

As discussed above, the majority of computer crashes occur due to device drivers causing instability in the operating system. As will be understood by those skilled in the art, a portion of these crashes are caused due to poorly written device drivers or device drivers being instructed to perform illegal operations. Even though, as contemplated in the present discussion, the device driver is isolated from the operating system, the device driver is capable of performing illegal operations. In such situations, messages being passed to the device driver go undelivered, and operations intended to be executed on the device itself go unperformed. At block 555, the virtual machine monitor 225 detects a driver that has crashed. The detection may be through any suitable means and may include, without limitation, number of messages undelivered, non-response to a periodic status query, crash notification sent by the virtual machine containing the device driver that crashed or the like.

At block 555, the virtual machine monitor 225 causes the device driver to be re-started. This may include, without limitation, sending instructions to the virtual machine to restart the device driver, re-executing the virtual machine containing the device driver, sending instructions to the virtual machine to restart the driver container 220 containing the device driver. At block 560, it is determined if there are any messages addressed to the device driver that are pending and were not delivered. If it is determined that there are pending messages, those pending messages are delivered to the device driver at block 565.

Though the operations depicted in FIG. 3, FIG. 4 and FIG. 5 are described as carried out on a virtual machine monitor 225, this is not meant to be limiting in any manner. Any device configured in a similar manner and carrying out the operations described herein are considered to be within the scope of the present discussion.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. Combinations of the above embodiments and other embodiments not specifically described herein will be apparent to those of skill in the art upon reviewing the above description.

The Abstract of the Disclosure is provided to comply with 37 C.F.R. §1.72(b), requiring an abstract that allows the reader to quickly ascertain the nature of the technical disclosure. It is submitted with the understanding that it will not be used to interpret or limit the scope or meaning of the claims. Additionally, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the terms “comprising” and “wherein,” respectively. Moreover, the terms “first,” “second,” and “third,” etc. are used merely as labels, and are not intended to impose numerical requirements on their objects.

What is claimed is:

1. Apparatus, comprising:
a first virtual machine; and
a second virtual machine, the second virtual machine including one or more drive containers to couple the first virtual machine, the one or more drive containers to be executed in a software environment isolated first virtual machine.

2. The apparatus of claim 1, further comprising a virtual machine monitor to control the operations of the first virtual machine and the second virtual machine, the virtual machine monitor to couple the first virtual machine and the second virtual machine.

3. The apparatus of claim 1, wherein the first virtual machine includes:
a host operating system;
one or more user applications; and
one or more device driver stubs, each of the one or more driver stubs to couple one or more of the one or more drive containers, the one or more device driver stubs is executed as a ring 0 software application.

4. The apparatus of claim 3, wherein the one or more drive containers includes a device driver to couple one or more device driver stubs, the device driver to be executed in a software environment isolated from the one or more device driver stubs.

5. The apparatus of claim 4, wherein the device driver is executed as a ring 0 software application.

6. The apparatus of claim 4, further including a virtual machine monitor to couple the first virtual machine, the second virtual machine and further virtual machines, the virtual machine to be further coupled to one or more platform devices.

7. The system of claim 4, wherein the virtual machine monitor is to receive messages from the one or more device driver stubs contained in the first virtual machine and to send messages to the device driver contained in the second virtual machine.

8. A system, comprising:
a PCI bus; and
a storage device, the storage device containing instructions which when executed, cause the following software modules to be performed:
a first virtual machine; and
a second virtual machine, the second virtual machine including one or more drive containers to couple the first virtual machine, the one or more drive containers to be executed in a software environment isolated from the first virtual machine.

9. The system of claim 8, wherein the storage device contains further instructions which when executed, cause the following software module to be operated: virtual machine monitor to control the operations of the first virtual machine and the second virtual machine, the virtual machine monitor to couple the first virtual machine and the second virtual machine.

10. The system of claim 9, wherein the first virtual machine includes:
a host operating system;
one or more user applications; and
one or more device driver stubs, each of the one or more driver stubs to couple one or more of the one or more drive containers, the one or more device driver stubs executed as a ring 0 software application.

11. The system of claim 10, wherein the virtual machine monitor is to receive messages from the one or more device driver stubs contained in the first virtual machine and to send messages to a device driver contained in the second virtual machine.

12. The system of claim 11, wherein the device driver stub is isolated from the device driver.

13. The system of claim 12, wherein the device driver is contained within a driver container contained in the second virtual machine.

14. A method, comprising:
executing an operating system as a virtual machine;
determining if one or more device drivers are to be initialized to the operating system; and
creating a device driver stub to be executed in the operating system for the additional driver if it is determined that there are one or more drivers to be initialized to the operating system, wherein the device driver stub is not coupled directly to the device controlled by the device driver.

15. The method of claim 14, wherein the device driver is isolated from the operating system.

16. The method of claim 14, further comprising:
receiving a message from the operating system, the message addressed to at least one platform device; and
multicasting the message to all of one or more drive containers, each of the one or more drive containers including a device driver.

17. The method of claim 14, further comprising:
receiving a message from the operating system, the message addressed to at least one platform device; and
sending the message to a driver container, the driver container including the device driver coupled to the at least one platform device.

18. A machine-readable medium having machine-executable instructions contained therein, which when executed perform the following operations:
executing an operating system as a virtual machine;
determining if one or more device drivers are to be initialized to the operating system; and
creating a device driver stub to be executed in the operating system for the additional driver if it is determined that there are one or more drivers to be initialized to the operating system, wherein the device driver stub is not coupled directly to the device controlled by the device driver.

19. The machine-readable medium of claim 18, wherein the device driver is isolated from the operating system.

20. The machine-readable medium of claim 18, further comprising:
detecting a non-responsive device driver;
restarting the non-responsive device driver; and
determining if any previously received messages addressed to the non-responsive device driver are pending; and
sending the pending messages to the non-responsive device driver if it is determined if there are previously received messages addressed to the non-responsive device driver.

21. The machine-readable medium of claim 18, wherein restarting the non-responsive device driver includes re-executing the virtual machine containing the non-responsive device driver.
